(19) United States
(12) Patent Application Publication
(10) Pub. No.: US 2026/0330934 A1
(43) Pub. Date: Oct. 22, 2026

(54) FantasyTrack: Pari-Mutuel Payout Fantasy Sports System

(71) Applicant: Justin Jones, Chaska, MN (US)

(72) Inventor: Justin Jones, Chaska, MN (US)

(21) Appl. No.: 19/271,482

(22) Filed: Jul. 16, 2025

Related U.S. Application Data
(60) Provisional application No. 63/792,464, filed on Apr. 22, 2025.

(51) Int. Cl. G07F 17/32; G06Q 50/34

(52) U.S. Cl. CPC G07F 17/3288; G06Q 50/34; G07F 17/323; G07F 17/3258

(57) ABSTRACT

A system and method for conducting a fantasy sports contest in which users select one or more athletes participating in a real-world sporting event. Pre-event odds are assigned to each athlete or combination based on performance projections and anticipated opportunity. Odds are updated dynamically as user entries are received and locked prior to the event?s start. After the event, real-world performance data is received, fantasy scores are calculated using a predefined scoring system, users are ranked based on their scores, and payouts are distributed according to a pari-mutuel formula based on the locked odds and final user rankings.

### FIELD OF THE INVENTION

The present invention relates generally to fantasy sports contests and, more particularly, to systems and methods for conducting fantasy sports contests utilizing pari-mutuel payout structures based on real-world athlete performance.

### BACKGROUND OF THE INVENTION

Traditional fantasy sports contests and daily fantasy sports (DFS) platforms typically use fixed entry fees and predetermined prize structures that rely on head-to-head matchups or salary-cap formats. These models lack the dynamic, market-based odds and pooled payout systems that characterize pari-mutuel wagering. There remains a need for a fantasy contest format that preserves the legal compliance and skill-based structure of DFS while incorporating the variable odds, liquidity, and engagement benefits of a pari-mutuel framework.

### BRIEF SUMMARY

Embodiments of the present disclosure relate to Fantasy Track, a Pari-Mutuel Payout Fantasy Sports System. In some embodiments, the system includes a computer-implemented method for conducting a fantasy sports contest comprising receiving user selections, assigning pre-event odds, dynamically updating odds, locking odds, receiving performance data, calculating fantasy scores, ranking users, and distributing payouts using a pari-mutuel formula.

### BRIEF DESCRIPTION OF THE DRAWINGS

FIG. 1 is a block diagram illustrating Fantasy Track.

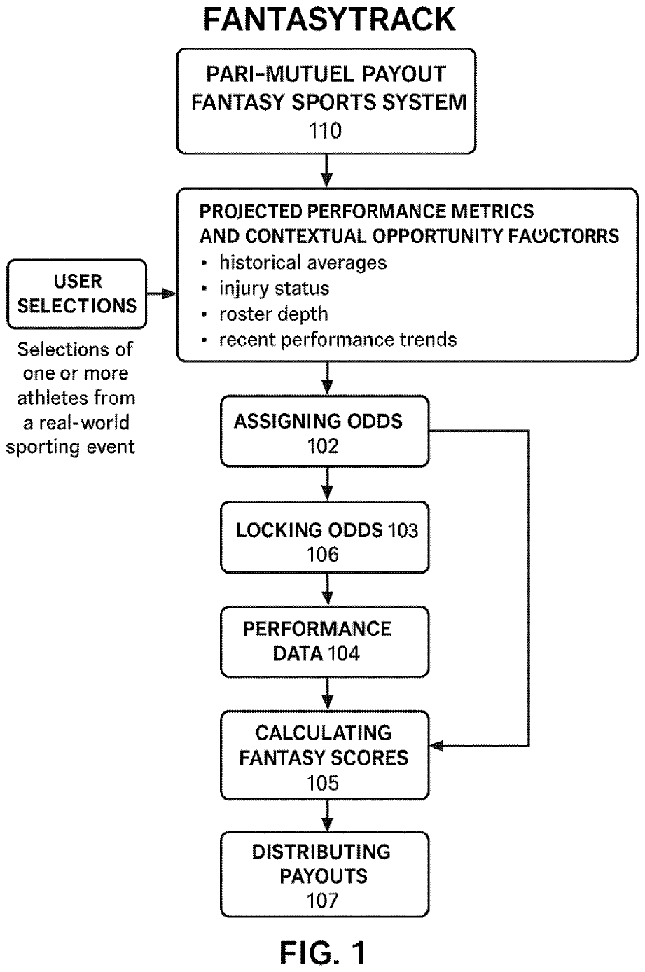

FIG. 2 illustrates a process flow of user interaction, entry submission, odds generation, and result determination.

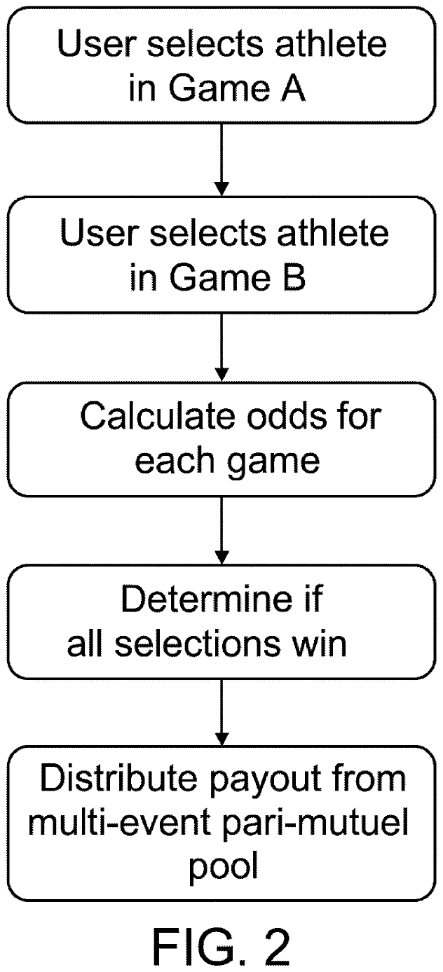

### DETAILED DESCRIPTION

The system supports multiple contest types inspired by pari-mutuel horse racing formats. Users may enter Win, Exacta, Trifecta, and Superfecta contests, including boxed variations.

Each contest operates on a separate pari-mutuel pool with independent odds and payouts.

1. A computer-implemented method for conducting a fantasy sports contest, comprising:
a. receiving, from a plurality of users, a selection of one or more athletes participating in a real-world sporting event;
b. assigning pre-event odds to each athlete or athlete combination based on projected performance metrics and anticipated opportunity, including factors such as historical averages and roster changes;
c. dynamically updating the odds based on the aggregate volume of user selections for each athlete or athlete combination;
d. locking the odds at a predefined time prior to the start of the sporting event;
e. receiving post-event performance data corresponding to the selected athletes;
f. calculating fantasy scores for each user based on a predefined scoring system;
g. ranking athletes based on their calculated fantasy scores to determine final contest outcomes; and
h. distributing payouts to users who correctly selected the top-ranked athlete or combination of athletes, according to a pari-mutuel formula based on locked odds, contest type, and wagered amount.

2. The method of claim 1, wherein the projected performance metrics used in assigning pre-event odds include one or more of: historical fantasy points, opponent matchup ratings, and changes in team depth charts or injury status.

3. The method of claim 1, wherein the odds are displayed to users in real time and updated continuously until the predefined lock time.

4. The method of claim 1, wherein the contest includes multiple contest types selectable by the user, including win, exacta, trifecta, and superfecta formats, with optional boxing of selections, and wherein the odds and payouts are calculated separately for each contest type.

5. The method of claim 1, wherein the payouts are distributed from a prize pool funded by user wagers, and the amount awarded to each user is proportional to the total amount wagered on the same athlete or athlete combination.

6. The method of claim 1, wherein the scoring system applies sport-specific rules, including but not limited to: yards gained, touchdowns scored, field goals made, or fantasy points awarded based on league-standard scoring systems.

7. The method of claim 1, wherein users are permitted to wager variable amounts of money on their selected athletes or athlete combinations, and wherein each user?s payout is calculated proportionally based on the amount wagered and the pari-mutuel odds associated with the selected athlete or athlete combination.
